(19) United States
(12) Patent Application Publication
(10) Pub. No.: US 2025/0181505 A1
(43) Pub. Date: Jun. 5, 2025

(54) METHOD, APPARATUS, ELECTRONIC DEVICE, AND STORAGE MEDIUM FOR PROCESSING A CONTENT RECOMMENDATION REQUEST

(71) Applicant: Lemon Inc., Grand Cayman (KY)

(72) Inventors: Luyu LI, Beijing (CN); Lei MA, Beijing (CN); Yifan YANG, Beijing (CN); Haiyu TANG, Beijing (CN)

(21) Appl. No.: 18/967,297

(22) Filed: Dec. 3, 2024

(30) Foreign Application Priority Data
Dec. 4, 2023 (CN) 202311652023.6

(51) Int. Cl. G06F 12/0813

(52) U.S. Cl. CPC G06F 12/0813; G06F 2212/60

(57) ABSTRACT

The present disclosure relates to the field of network communication, and in particular, to a content recommendation request processing method and apparatus, an electronic device, and a storage medium. According to the method provided in embodiments of the present disclosure, whether a content recommendation request is a retry request is determined based on a target request identifier. If the content recommendation request is a retry request, it indicates that a client has failed to obtain recommended content before. In this case, a server may directly obtain the request identifier and corresponding target recommended content from a cache, and during this process, the recommended content is not required to be re-pulled by using a recommendation service.

### CROSS-REFERENCE TO RELATED APPLICATION(S)

This application claims priority to Chinese Application No. 202311652023.6 filed Dec. 4, 2023, the disclosure of which is incorporated herein by reference in its entity.

### FIELD

The present disclosure relates to the field of network communication, and in particular, to a content recommendation request processing method and apparatus, an electronic device, and a storage medium.

### BACKGROUND

Currently, in areas with poor network environments, a failure rate (failure rate=(number of failures/total number of requests)×100%) of a client requesting for recommended content is high during a peak service period (with a heavy service load and a high latency). The client sends a new content recommendation request after failing to request for the recommended content. In this case, a system will recommend a new batch of content to the client based on the request.

### SUMMARY

In view of the above, embodiments of the present disclosure provide a content recommendation request processing method and apparatus, an electronic device, and a storage medium, so as to solve the problem that a high failure rate may lead to an incapability of a client to obtain recommended content in time or inaccuracy of obtained recommended content, and also causes a waste of a large amount of effective push content.

According to a first aspect, an embodiment of the present disclosure provides a content recommendation request processing method. The method includes:
receiving a content recommendation request from a target client, where the content recommendation request includes a target request identifier;
verifying the target request identifier to obtain a request type corresponding to the content recommendation request;
if the request type is a retry type, obtaining corresponding target recommended content from a cache by using the target request identifier, where the cache is configured to store request identifiers corresponding to different clients and recommended content corresponding to the request identifiers; and
sending the target recommended content to the target client.

According to a second aspect, an embodiment of the present disclosure provides a content recommendation request processing apparatus. The apparatus includes:
a receiving module configured to receive a content recommendation request from a target client, where the content recommendation request includes a target request identifier;
a verification module configured to verify the target request identifier to obtain a request type corresponding to the content recommendation request;
an obtaining module configured to: if the request type is a retry type, obtain corresponding target recommended content from a cache by using the target request identifier, where the cache is configured to store request identifiers corresponding to different clients and recommended content corresponding to the request identifiers; and
a sending module configured to send the target recommended content to the target client.

According to a third aspect, an embodiment of the present disclosure provides an electronic device, including a memory and a processor, where the memory and the processor are in communication connection to each other, the memory stores computer instructions, and the processor executes the computer instructions to perform the method according to the first aspect or any implementation corresponding to the first aspect.

According to a fourth aspect, an embodiment of the disclosure provides a computer-readable storage medium having stored thereon computer instructions that are used to cause a computer to perform the method according to the first aspect or any implementation corresponding to the first aspect.

### BRIEF DESCRIPTION OF THE DRAWINGS

To more clearly describe the technical solutions in specific implementations of the present disclosure or in the prior art, the accompanying drawings for describing the specific implementations or the prior art will be briefly described below. Apparently, the accompanying drawings in the description below show some implementations of the present disclosure, and those of ordinary skill in the art may still derive other accompanying drawings from these accompanying drawings without creative efforts.

FIG. 1 is a schematic diagram in which a client retries to obtain recommended content according to some embodiments of the present disclosure;

FIG. 2 is a schematic flowchart of a content recommendation request processing method according to some embodiments of the present disclosure;

FIG. 3 is a schematic flowchart of a content recommendation request processing method according to some embodiments of the present disclosure;

FIG. 4 is a schematic diagram of a scenario of a content recommendation request processing method according to some embodiments of the present disclosure;

FIG. 5 is a sequence diagram of a content recommendation request processing method according to some embodiments of the present disclosure;

FIG. 6 is a block diagram of a structure of a content recommendation request processing apparatus according to an embodiment of the present disclosure; and

FIG. 7 is a schematic diagram of a hardware structure of an electronic device according to an embodiment of the present disclosure.

### DETAILED DESCRIPTION OF EMBODIMENTS

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative efforts shall fall within the scope of protection of the present disclosure.

In the process described above, the recommended content that the client fails to obtain is not included in the new batch of recommended content. Therefore, a high failure rate may lead to an incapability of the client to obtain the recommended content in time or inaccuracy of obtained recommended content, and also causes a waste of a large amount of effective push content.

According to the method provided in the embodiments of the present disclosure, whether the content recommendation request is a retry request is determined based on the target request identifier. If the content recommendation request is a retry request, it indicates that the client has failed to obtain recommended content before. In this case, a server may directly obtain the request identifier and the corresponding target recommended content from a cache, and during this process, the recommended content is not required to be re-pulled by using a recommendation service. Therefore, it is ensured that the target client can obtain effective and accurate recommended content in time, and the problem of inaccuracy of the recommended content obtained by the client after a content obtaining failure is solved. In addition, the recommended content is stored in the cache, so that the server can quickly retrieve the cache, avoiding overheads of frequently accessing the recommendation service or repeatedly calculating recommended content.

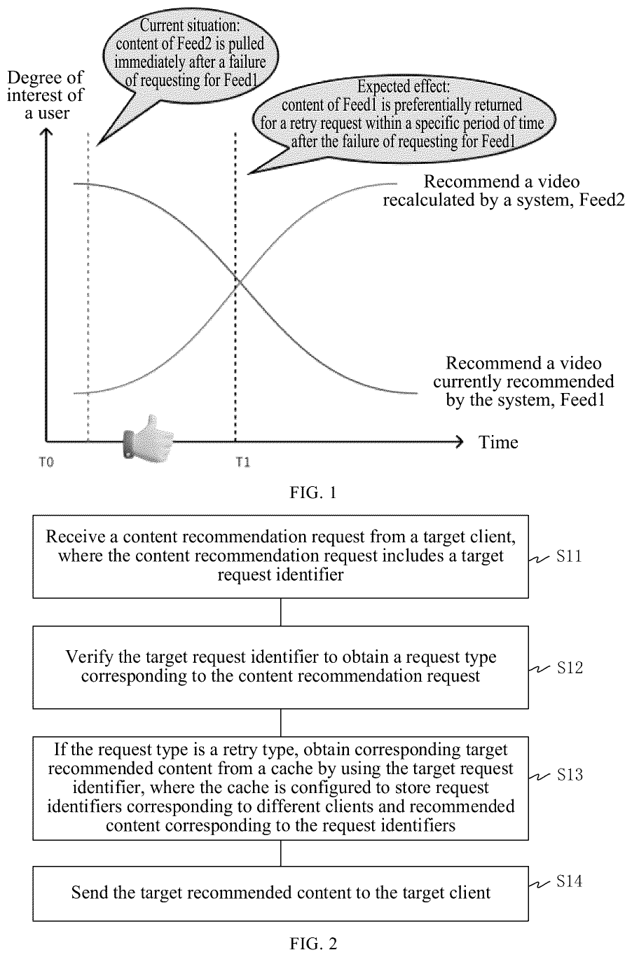

Currently, after failing to obtain recommended content for the first time (the recommended content obtained for the first time is denoted as Feed1), a client resends a content recommendation request, where recommended content obtained then is denoted as Feed2. As shown in FIG. 1, a degree of interest in starting content of Feed2 is lower than that of starting content of Feed1 because the starting content of Feed1 may be understood as recommended content with the top N degrees of interest. Recommended content can be selected at the same time from only (total-top N) videos as Feed2. However, the selected recommended content may not match recommended content that the client expects to obtain.

For Feed2, push content may be dynamically updated over time, and recommended content with a higher degree of interest may be obtained based on a behavior (like, play, and share) of the client. However, for Feed1, a degree of interest in the recommended content decreases over time due to timeliness of the content.

A point T1 in FIG. 1 is related to the following several factors.

\textcircled{1} a Speed at which a New Browsing Behavior Takes Effect on Recommended Content of a Model

Different browsing behaviors even take effect at different speeds. The fastest is 30 seconds, and the speed is usually at a minute level, with the longest being 10 minutes. A current direction of interest of a user can be more accurately determined based on more newer user actions.

\textcircled{2} a Speed at which the Timeliness of the Content Falls

Timeliness of different content falls at different speeds. For example, timeliness of live streaming, an advertisement, and a video from a friend may be higher than that of a video from a stranger.

\textcircled{3} a Supply of Content in which the User is Interested

If the supply is low or the user is currently interested in few points (for example, likes only encyclopedia of insects), there is a larger content pool for Feed1 than Feed2 to select. T1 correspondingly moves forwards, and a value of idempotence is greater.

In conclusion, if the client performs recommended content obtaining again after failing to obtain the recommended content for the first time, the client cannot obtain effective recommended content in time, and recommended content obtained subsequently is inaccurate.

On this basis, the embodiments of the present disclosure provide a content recommendation request processing method and apparatus, an electronic device, and a storage medium, to solve the above technical problem. It should be noted that the steps shown in the flowchart of the accompanying drawings may be performed, for example, in a computer system including a group of computer-executable instructions. In addition, although a logical sequence is shown in the flowchart, in some cases, the steps shown or described may be performed in a different sequence.

It can be understood that before the use of the technical solutions disclosed in the embodiments of the present disclosure, a user shall be informed of a type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

In the embodiments, there is provided a content recommendation request processing method. FIG. 2 is a flowchart of a content recommendation request processing method according to an embodiment of the present disclosure. As shown in FIG. 2, the process includes the following steps.

Step S11: Receive a content recommendation request from a target client, where the content recommendation request includes a target request identifier.

In this embodiment of the present disclosure, a server receives the content recommendation request sent by the target client. The target client may be any one of a plurality of clients related to a recommendation service of the server. The recommendation service analyzes a behavior, an interest, a preference, and other data of a user to generate related content based on an algorithm model and a data processing technology, such as a commodity, news, music, a video, and a social media post, and recommend the related content to the client. The recommendation service may be used on the plurality of clients, such as an e-commerce platform, a news application, a social media platform, and a music streaming application.

In this embodiment of the present disclosure, the content recommendation request is used to obtain recommended content corresponding to the target client, and the recommended content may be video content, advertisement content, game content, or the like. The content recommendation request usually includes some identification information, including the target request identifier (token). The target request identifier is an identifier for uniquely identifying a specific content recommendation request. The identifier may be a character string, a number, or other types of values for distinguishing different requests. When the target client sends a request, a unique identifier (the target request identifier) is usually carried in the request, and the server can subsequently recognize idempotence of the request based on the identifier.

After receiving the content recommendation request, the server parses the target request identifier in the content recommendation request, to learn about a specific operation or service logic corresponding to the request. For example, the server may determine, based on the target request identifier, a content type required by the target client. If the target request identifier indicates that the target client needs to obtain the advertisement content, the server may execute logic of obtaining advertisement content; or if the target request identifier indicates that the user needs to obtain the video content, the server may execute logic of obtaining video content.

Step S12: Verify the target request identifier to obtain a request type corresponding to the content recommendation request.

In this embodiment of the present disclosure, when the target client sends the content recommendation request, a specific retry field may be added to the target request identifier, for example, the retry identification field is set to “retry” or another self-defined identifier. This identifier is used to indicate that the request is a retry request. After receiving the content recommendation request, the server first parses the target request identifier, and checks whether the retry field is included. Whether the content recommendation request is of the retry type may be determined by determining a specific field or value in the request. If the retry field is included in the target request identifier, it indicates that the request type corresponding to the content recommendation request is the retry type. In contrast, if the retry field is not included in the target request identifier, it indicates that the request type corresponding to the content recommendation request is a non-retry type.

Step S13: If the request type is the retry type, obtain corresponding target recommended content from a cache by using the target request identifier, where the cache is configured to store request identifiers corresponding to different clients and recommended content corresponding to the request identifiers.

In this embodiment of the present disclosure, if the request type is the retry type, the server obtains the target recommended content corresponding to the target request identifier from the cache, where the cache may be Abase, high throughput and highly available NoSQL. The cache stores the request identifiers corresponding to the different clients and the recommended content corresponding to the request identifiers.

It should be noted that storing the request identifier of the client and the recommended content corresponding to the request identifier in the cache can ensure that when resending the content recommendation request after a request failure, the client can still obtain recommended content with a high degree of interest, without re-pulling the recommended content by using the recommendation service. Therefore, it is ensured that the target client can obtain effective and accurate recommended content in time, and the problem of inaccuracy of the recommended content obtained by the client after a content obtaining failure is solved. In addition, the server can quickly retrieve the cache by caching a recommendation result in a high-throughput and highly available NoSQL storage, avoiding overheads of frequently accessing the recommendation service or repeatedly calculating a recommendation result, increasing a response speed, and improving an overall throughput capacity.

Step S14: Send the target recommended content to the target client.

In this embodiment of the present disclosure, the server packages the target recommended content to obtain a file package, and then sends the file package to the target client.

As an example, a client A is a short video APP, and various types of video content may be viewed and shared by using the client. In this example, the server may obtain the target recommended content corresponding to the target request identifier from the cache, where the target recommended content may be a literature video, a game video, or the like. Specifically, when the client A needs to browse a video, the client first generates a query request and assigns a unique target request identifier Token to the content recommendation request. The client A sends a content recommendation request carrying the target request identifier, and the server first verifies the target request identifier after receiving the request from the client A. The server queries the cache to check whether there is recommended video content corresponding to Token. If there is a recommendation result corresponding to Token in the cache and the recommendation result is the video content, the server obtains the video content from the cache, and packages and sends the video content to the client A.

As an example, a client B is an e-commerce APP, and various types of commodities, advertisements, and other information may be browsed by using the client. In this example, the server may obtain the target recommended content corresponding to the target request identifier from the cache, where the target recommended content may be commodity content or advertisement content. Specifically, when receiving a content recommendation request from the client B, the server obtains corresponding target recommended content from the cache based on a target request identifier in the content recommendation request. After obtaining the target recommended content from the cache, the server packages the advertisement content to generate a data file or message body including the advertisement content, for example, a JSON file. The file may include advertisement-related information, such as an advertisement picture, an advertisement title, an advertisement description, and an advertisement link.

According to the method provided in this embodiment of the present disclosure, whether the content recommendation request is a retry request is determined based on the target request identifier. If the content recommendation request is a retry request, it indicates that the client has failed to obtain recommended content before. In this case, the server may directly obtain the request identifier and the corresponding target recommended content from the cache, and during this process, the recommended content is not required to be re-pulled by using the recommendation service. Therefore, it is ensured that the target client can obtain effective and accurate recommended content in time, and the problem of inaccuracy of the recommended content obtained by the client after the content obtaining failure is solved. In addition, the recommended content is stored in the cache, so that the server can quickly retrieve the cache, avoiding the overheads of frequently accessing the recommendation service or repeatedly calculating recommended content.

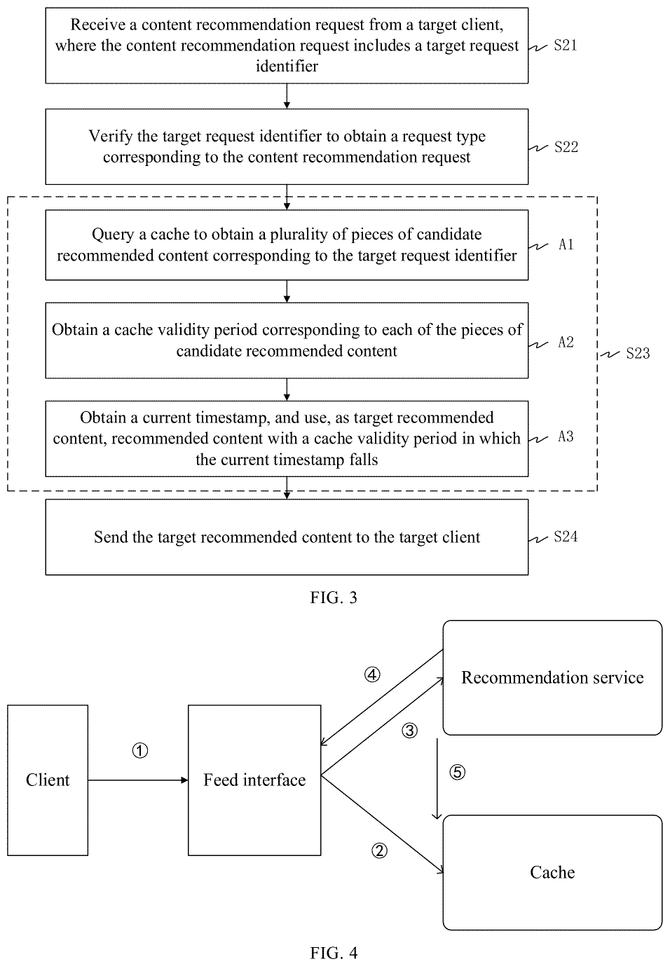

FIG. 3 is a flowchart of a content recommendation request processing method according to an embodiment of the present disclosure. As shown in FIG. 3, the process includes the following steps.

Step S21: Receive a content recommendation request from a target client, where the content recommendation request includes a target request identifier. For details, refer to step S11 in the embodiment shown in FIG. 2. Details are not described herein again.

Step S22: Verify the target request identifier to obtain a request type corresponding to the content recommendation request.

In this embodiment of the present disclosure, the verifying the target request identifier to obtain a request type corresponding to the content recommendation request includes: obtaining a historical content recommendation request sent by the target client within a current recommendation period, and constructing a historical content recommendation request set by using the historical content recommendation request; detecting whether the historical content recommendation request set includes a historical content recommendation request including the target request identifier; and if the historical content recommendation request including the request identifier is included, determining that the request type is a retry type; or if the historical content recommendation request including the request identifier is not included, determining that the request type is a non-retry type. It should be noted that the current recommendation period may be set based on a request frequency of the client, for example, 30 minutes or 1 hour.

Specifically, the historical content obtaining request set of the target client is obtained. Each content obtaining request includes a request identifier token. The historical content obtaining request set is traversed to check whether each request in the historical content obtaining request set includes a same request identifier as the target request identifier. Then, a request type determining process is performed.

\textcircled{1} The historical content recommendation request including the target request identifier is included: if it is found that the historical content recommendation request set includes the request identifier including the target request identifier, it may be determined that the request type is the retry type. This means that when the target client tries to obtain recommended content before, an error occurs or the recommended content is not successfully obtained, and the target client is now trying to perform recommended content obtaining again.

\textcircled{2} The historical content recommendation request including the target request identifier is not included: if the historical content recommendation request set includes the same request identifier as the target request identifier, it may be determined that the request type is the non-retry type. This means that the client sends the request for the first time or recommended content has been successfully obtained for a previous request.

On this basis, the server may determine whether the request type is the retry type or the non-retry type based on a historical record of the target request identifier. In this way, the request of the client can be processed in a targeted manner, and whether to obtain the recommended content from a cache or generate new recommended content can be selected based on an actual situation.

Step S23: If the request type is the retry type, obtain corresponding target recommended content from the cache by using the target request identifier, where the cache is configured to store request identifiers corresponding to different clients and recommended content corresponding to the request identifiers.

In this embodiment of the present disclosure, if the request type is the retry type, it indicates that the client failed to obtain recommended content before. In this case, the server obtains the corresponding target recommended content by using the target request identifier.

Specifically, the obtaining corresponding target recommended content from a cache by using the target request identifier includes the following steps A1 to A3.

Step A1: Query the cache to obtain a plurality of pieces of candidate recommended content corresponding to the target request identifier.

In this embodiment of the present disclosure, the querying the cache to obtain candidate recommended content corresponding to the target request identifier includes the following steps A101 to A103.

Step A101: Obtain an account identifier and a device identifier that correspond to the target client, where the device identifier is an identifier of a smart device on which the target client is located.

In this embodiment of the present disclosure, when the client logs in or is registered, a user provides account information, such as a user name, a mobile phone number and an e-mail address. The server saves the account information in a database when the user logs in or is registered, and generates a unique account identifier for each user.

The smart device on which the target client is located usually has a unique device identifier, such as a device serial number, an IMEI number, and a MAC address. When the client establishes a connection to the server, the client may send device identification information to the server. After receiving a connection request from the client, the server may verify the account information provided by the client, to determine the account identifier corresponding to the target client.

According to the method provided in this embodiment of the present disclosure, the server may obtain, based on the device identification information sent by the client, the device identifier of the smart device on which the target client is located. The identification information such as the account identifier and the device identifier may be used at a server side to recognize and distinguish different clients, to provide a personalized service and recommended content for the target client.

Step A102: Generate a query condition based on the account identifier, the device identifier, and the target request identifier.

In this embodiment of the present disclosure, a unique query condition is generated by using the account identifier and the device identifier in combination with the target request identifier. The query condition may be a combination value or a specific character string.

Step A103: Query the cache by using the query condition, to obtain the candidate recommended content.

In this embodiment of the present disclosure, the generated query condition is compared with the recommended content stored in the cache. The query condition may be transferred to the cache by using a corresponding query statement or interface based on a data structure of the cache and a query mode, to retrieve matched candidate recommended content. The cache performs matching and screening based on the query condition, and returns the candidate recommended content satisfying the query condition.

Step A2: Obtain a cache validity period corresponding to each of the pieces of the candidate recommended content.

In this embodiment of the present disclosure, the obtaining a cache validity period corresponding to each pieces of the candidate recommended content includes: obtaining an update frequency and a degree of importance that correspond to the candidate recommended content; and configuring, based on the update frequency and the degree of importance, the cache validity period corresponding to the candidate recommended content.

Specifically, first, the update frequency of the recommended content is determined based on a service requirement and a characteristic of the recommended content. The update frequency may be different time units such as seconds, minutes, hours, and days. For example, some recommended content may be required to be updated daily, while other content may be updated hourly. Then, the degree of importance of the candidate recommended content is determined based on importance of the recommended content and a requirement of the client. A plurality of degrees may be defined based on the service requirement, such as high, medium, and low, or different degrees of importance are represented by numbers. For example, a shorter validity period may be used for important recommended content, while a longer validity period may be used for less important content. Finally, the cache validity period corresponding to the candidate recommended content is configured at the server side based on the update frequency and the degree of importance that are determined and in combination with the service requirement and system performance.

For example, a shorter cache validity period may be set for recommended content that is frequently updated and has a high degree of importance, to ensure that the recommended content can be updated in time and the client can obtain a latest recommendation as soon as possible. A long cache validity period may be set for recommended content with a low update frequency or a low degree of importance, to reduce frequent access to server resources and improve the system performance and a response speed.

Step A3: Obtain a current timestamp, and use, as the target recommended content, recommended content with a cache validity period in which the current timestamp falls.

In this embodiment of the present disclosure, the server may obtain the current timestamp by using a time function or a time library provided by a system. The cache validity period corresponding to the candidate recommended content is obtained based on the update frequency and the degree of importance that are preconfigured. The cache validity period may be represented as a time period, such as 30 minutes and 1 hour, or as a specific date and time. The candidate recommended content in the cache is traversed to determine whether a cache time range of each of the pieces of recommended content includes the current timestamp. The recommended content whose cache time range includes the current timestamp is found from the cache, and is used as the target recommended content.

Step S24: Send the target recommended content to the target client. For details, refer to step S14 in the embodiment shown in FIG. 2. Details are not described herein again.

According to the method provided in this embodiment of the present disclosure, whether the content recommendation request is a retry request is determined based on the target request identifier. If the content recommendation request is a retry request, it indicates that the client has failed to obtain recommended content before. In this case, the server may directly obtain the request identifier and the corresponding target recommended content from the cache, and during this process, the recommended content is not required to be re-pulled by using a recommendation service. Therefore, it is ensured that the target client can obtain effective and accurate recommended content in time, and the problem of inaccuracy of the recommended content obtained by the client after a content obtaining failure is solved. In addition, the recommended content is stored in the cache, so that the server can quickly retrieve the cache, avoiding overheads of frequently accessing the recommendation service or repeatedly calculating recommended content.

In this embodiment of the present disclosure, the method further includes the following steps B1 to B4.

Step B1: Obtain client information of the target client when there is no candidate recommended content corresponding to the target request identifier in the cache or the cache validity period corresponding to the candidate recommended content is invalid.

In this embodiment of the present disclosure, when there is no candidate recommended content corresponding to the target request identifier in the cache or the cache validity period of the candidate recommended content is invalid, it indicates that the corresponding candidate recommended content has not been generated when the target client sends a content recommendation request before, leading to no related content in the cache, or the candidate recommended content in the cache has expired. In this case, the client information of the target client is obtained. The client information may include the account identifier, the device identifier, and the like.

Step B2: Generate a query request based on the client information of the target client.

In this embodiment of the present disclosure, the query request is constructed based on the account identifier and the device identifier of the target client. A request parameter may include the following content: the account identifier: which represents a unique identifier of the user, and is used to identify a user identity of the target client; the device identifier: which represents a unique identifier of a client device, and is used to identify a device identity of the target client; and a content type: which represents a current service type of the client, and may be a video, an advertisement, a game, or the like.

Step B3: Send the query request to a recommendation service system, where the recommendation service system is configured to feed back the target recommended content based on the client information in the query request.

In this embodiment of the present disclosure, the constructed query request is sent to the recommendation service system. An HTTP request mode may be used to send the query request to an interface address specified by the recommendation service system. The recommendation service system obtains corresponding key information based on the account identifier. The key information includes content of interest, a behavior preference, a historical record that correspond to an account. The recommendation service system obtains, based on the device identifier, device feature information related to the device. A device feature may include a device type, an operating system version, a screen resolution, and the like, and is used to learn about a technical capability and a display environment of the client. The recommendation service system performs personalized recommendation by using a recommendation algorithm based on the key information and the device feature. The recommendation algorithm may comprehensively consider the content of interest and the preference of the account and the display environment of the client, to generate the target recommended content.

Step B4: Receive the target recommended content from the recommendation service system, write the target recommended content into the cache, and send the target recommended content to the target client.

In this embodiment of the present disclosure, the recommendation service system may match and screen, based on a recommendation result generated by the recommendation algorithm, recommended content satisfying a feature of the client and a user preference, and finally return the push content. In addition, after the returned target recommended content is received, the target push content is stored in the cache, so that the client does not retry after failing to receive the target push content, and can quickly obtain the corresponding target push content.

As an example, as shown in FIG. 4: \textcircled{1} the client sends the content recommendation request to a Feed interface. \textcircled{2} The Feed interface queries the cache by using the target request identifier in the content recommendation request. \textcircled{3} If there is no target recommended content corresponding to the target request identifier in the cache, the Feed interface generates the query request based on the client information, and sends the query request to the recommendation service system. \textcircled{4} The recommendation service system pulls related target recommended content based on the query request, and returns the related target recommended content to the Feed interface. \textcircled{5} The Feed interface synchronizes the target recommended content to the cache at the same time.

In this embodiment of the present disclosure, the method further includes: triggering a cache clearing mechanism if the request type is a non-retry type; and querying, in the cache based on the cache clearing mechanism, a historical request identifier corresponding to the target client, and clearing historical recommended content corresponding to the historical request identifier from the cache, where the historical request identifier is a previous request identifier of the target request identifier.

Specifically, when the content recommendation request of the client arrives at the server, it is first necessary to determine whether the request type is the non-retry type. A request of the non-retry type may be understood as follows: the target request identifier used by the client does not appear in a current cycle, and it is necessary to obtain latest recommended content directly from the recommendation service system.

The cache clearing mechanism is triggered if the request type is the non-retry type. The cache clearing mechanism may be a timing strategy, or a conditional strategy triggered based on a request. Different cache clearing strategies may be set based on a system requirement and performance, such as timed clearing and LRU (least recently used). After the cache clearing mechanism is triggered, the previous request identifier of the target request identifier is used as a request identifier for clearing. In this case, the recommended content stored in the cache is retrieved, and matching is performed based on the request identifier for clearing, to find recommended content required to be cleared. After the corresponding recommended content in the cache is cleared, the recommendation service system may update the cache, so that latest recommended content may be generated and stored for a next request. In this way, the response speed for a subsequent request and the system performance can be improved.

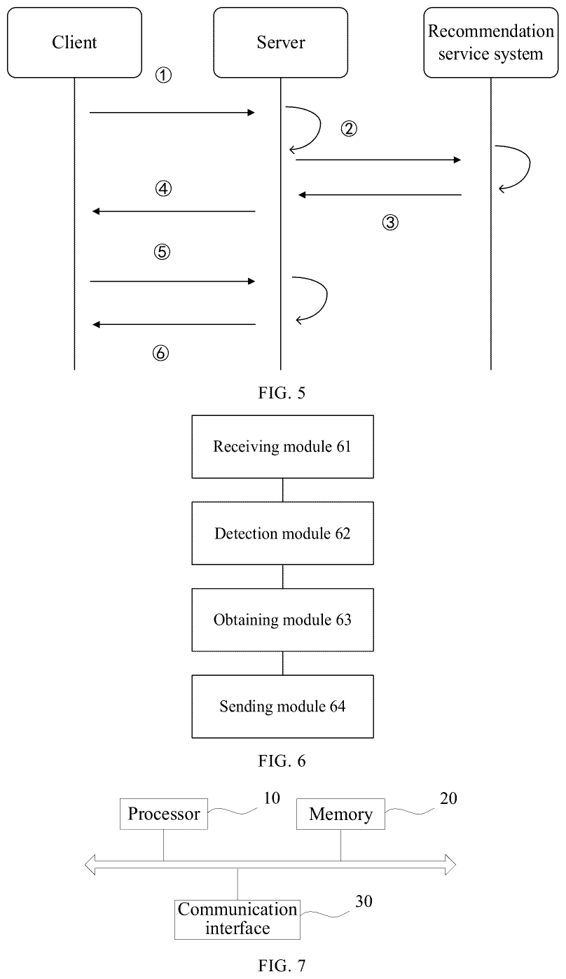

FIG. 5 is a diagram of interaction in a content recommendation request processing method according to an embodiment of the present disclosure. As shown in FIG. 5, the process includes the following steps.

Step \textcircled{1}: A client sends, to a server for the first time, a content recommendation request carrying a target request identifier.

Step \textcircled{2}: After receiving the content recommendation request, the server queries, in a cache, whether there is target recommended content corresponding to the target request identifier. If there is no target recommended content corresponding to the target request identifier, the server generates a query request based on client information of the client, and sends the query request to a recommendation service system.

Step \textcircled{3}: The recommendation service system pulls the corresponding target recommended content based on the client information, and returns the corresponding target recommended content to the server.

Step \textcircled{4}: The server writes the target recommended content into the cache, and transmits the target recommended content to the client.

Step \textcircled{5}: The client fails to obtain the target recommended content, and performs a retry operation, that is, sends, to the server again, the content recommendation request carrying the target request identifier.

Step \textcircled{6}: The server obtains the target recommended content corresponding to the target request identifier from the cache, verifies whether the target recommended content is invalid, and if the target recommended content is not invalid, sends the target recommended content to the client.

According to the method provided in this embodiment of the present application, the server first queries, in the cache, the target recommended content corresponding to the target request identifier. If there is the content in the cache, the content may be obtained directly from the cache, avoiding an additional request and calculation process and improving a response speed and system performance. If the client fails to obtain the target recommended content, the retry operation may be performed to obtain effective recommended content in which the client is interested, increasing a success rate of obtaining recommended content and solving the problem of inaccuracy of content obtained by the client after a content obtaining failure.

In this embodiment, there is further provided a content recommendation request processing apparatus. The apparatus is configured to implement the above embodiments and preferred implementations. Details about what has been described are not described herein again. As used below, the term “module” may implement a combination of software and/or hardware having predetermined functions. Although the apparatus described in the following embodiments is preferably implemented by software, implementation by hardware or the combination of the software and the hardware is also possible and conceivable.

This embodiment provides the content recommendation request processing apparatus. As shown in FIG. 6, the apparatus includes:
a receiving module 61 configured to receive a content recommendation request from a target client, where the content recommendation request includes a target request identifier;
a verification module 62 configured to verify the target request identifier to obtain a request type corresponding to the content recommendation request;
an obtaining module 63 configured to: if the request type is a retry type, obtain corresponding target recommended content from a cache by using the target request identifier, where the cache is configured to store request identifiers corresponding to different clients and recommended content corresponding to the request identifiers; and
a sending module 64 configured to send the target recommended content to the target client.

In this embodiment of the present disclosure, the verification module 62 is configured to: obtain a historical content recommendation request set corresponding to the target client; detect whether the historical content recommendation request set includes a historical content recommendation request including the target request identifier; and if the historical content recommendation request including the request identifier is included, determine that the request type is the retry type; or if the historical content recommendation request including the request identifier is not included, determine that the request type is a non-retry type.

In this embodiment of the present disclosure, the obtaining module 63 is configured to: query the cache to obtain a plurality of pieces of candidate recommended content corresponding to the target request identifier; obtain a cache validity period corresponding to each of the pieces of the candidate recommended content; and obtain a current timestamp, and use, as the target recommended content, recommended content with a cache validity period in which the current timestamp falls.

In this embodiment of the present disclosure, the obtaining module 63 is configured to: obtain an account identifier and a device identifier that correspond to the target client, where the device identifier is an identifier of a smart device on which the target client is located; generate a query condition based on the account identifier, the device identifier, and the target request identifier; and query the cache by using the query condition, to obtain the candidate recommended content.

In this embodiment of the present disclosure, the obtaining module 63 is configured to: obtain an update frequency and a degree of importance that correspond to the candidate recommended content; and configure, based on the update frequency and the degree of importance, the cache validity period corresponding to the candidate recommended content.

In this embodiment of the present disclosure, the apparatus further includes a processing module configured to: obtain client information of the target client when there is no candidate recommended content corresponding to the target request identifier in the cache or the cache validity period corresponding to the candidate recommended content is invalid; generate a query request based on the client information of the target client; send the query request to a recommendation service system, where the recommendation service system is configured to feed back the target recommended content based on the client information in the query request; and receive the target recommended content from the recommendation service system, write the target recommended content into the cache, and send the target recommended content to the target client.

In this embodiment of the present disclosure, the apparatus further includes an update module configured to: trigger a cache clearing mechanism if the request type is the non-retry type; and query, in the cache based on the cache clearing mechanism, a historical request identifier corresponding to the target client, and clear historical recommended content corresponding to the historical request identifier from the cache, where the historical request identifier is a previous request identifier of the target request identifier.

Refer to FIG. 7, which is a schematic diagram of a structure of an electronic device according to an optional embodiment of the present disclosure. As shown in FIG. 7, the electronic device includes one or more processors 10, a memory 20, and an interface for connecting various components, including a high-speed interface and a low-speed interface. The components are communicatively connected to each other through different buses, and may be mounted on a public mainboard, or may be mounted in other ways according to requirements. The processor may process an instruction executed in the electronic device, including an instruction stored in the memory or on the memory for displaying graphical information of a GUI on an external input/output apparatus (such as a display device coupled to the interface). In some optional implementations, if necessary, a plurality of processors and/or a plurality of buses may be used together with a plurality of memories. Similarly, a plurality of electronic devices may be connected, and each device provides part of necessary operations (for example, as a server array, a set of blade servers, or a multiprocessor system).

The processor 10 may be a central processing unit, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable gate array, a generic array logic, or any combination thereof.

The memory 20 stores instructions executable by at least one processor 10, to cause the at least one processor 10 to perform and implement the method shown in the above embodiments.

The memory 20 may include a program storage area and a data storage area. The program storage area may store an operating system and an application required by at least one function. The storage data area may store data created according to the use of the electronic device displayed in a landing page of an applet, and the like. In addition, the memory 20 may include a high-speed random access memory, and may further include a non-transitory memory, such as at least one magnetic disk storage device, a flash memory device, or other non-transitory solid-state storage devices. In some optional implementations, the memory 20 optionally includes memories remotely arranged relative to the processor 10, and these remote memories may be connected to the electronic device through a network. Examples of the network include, but are not limited to, the Internet, an intranet, a local area network, a mobile communication network, and a combination thereof.

The memory 20 may include a volatile memory, such as a random access memory. The memory may further include a non-volatile memory, such as a flash memory, a hard disk, or a solid-state hard disk. The memory 20 may further include a combination of the above types of memories.

The electronic device further includes a communication interface 30 for the electronic device to communicate with other devices or communication networks.

An embodiment of the present disclosure further provides a computer-readable storage medium. The method according to the embodiments of the present disclosure may be implemented in hardware and firmware, is implemented as being recordable in a storage medium, or is implemented as computer code that is downloaded through a network and originally stored in a remote storage medium or a non-transitory machine-readable storage medium, and is to be stored in a local storage medium, so that the method described herein may be processed by software stored on a storage medium of a general-purpose computer, a special-purpose processor, or programmable or special-purpose hardware. The storage medium may be a magnetic disk, an optical disk, a read-only memory, a random access memory, a flash memory, a hard disk, or a solid state disk. Further, the storage medium may further include a combination of the above types of memories. It may be understood that the computer, the processor, the microprocessor controller, or the programmable hardware includes a storage assembly capable of storing or receiving software or computer code. When the software or the computer code is accessed or executed by the computer, the processor, or the hardware, the method shown in the above embodiments is implemented.

Although the embodiments of the present disclosure are described with reference to the accompanying drawings, those skilled in the art may provide various modifications and variations without departing from the spirit and scope of the present disclosure, and such modifications and variations shall all fall within the scope defined by the appended claims.

I/We claim:

1. A method for processing a content recommendation request, comprising:
receiving a content recommendation request from a target client, wherein the content recommendation request comprises a target request identifier;
verifying the target request identifier to obtain a request type corresponding to the content recommendation request;
in response to the request type being a retry type, obtaining a corresponding target recommended content from a cache by using the target request identifier, wherein the cache is configured to store request identifiers corresponding to different clients and recommended content corresponding to the request identifiers; and
sending the target recommended content to the target client.

2. The method according to claim 1, wherein verifying the target request identifier to obtain the request type corresponding to the content recommendation request comprises:
obtaining a historical content recommendation request set corresponding to the target client;
detecting whether the historical content recommendation request set contains a historical content recommendation request that includes the target request identifier; and
in response to detecting the historical content recommendation request that includes the request identifier, determining that the request type is the retry type; or, in response to not detecting the historical content recommendation request that includes the request identifier, determining that the request type is a non-retry type.

3. The method according to claim 1, wherein obtaining the corresponding target recommended content from the cache by using the target request identifier comprises:
querying the cache to obtain a plurality of candidate recommended contents corresponding to the target request identifier;
obtaining a cache validity period corresponding to each candidate recommended content; and
obtaining a current timestamp, and using, as the target recommended content, recommended content with a cache validity period in which the current timestamp falls.

4. The method according to claim 3, wherein querying the cache to obtain the candidate recommended contents corresponding to the target request identifier comprises:
obtaining an account identifier and a device identifier corresponding to the target client, wherein the device identifier is an identifier of a smart device on which the target client is located;
generating a query condition based on the account identifier, the device identifier, and the target request identifier; and
querying the cache by using the query condition, to obtain the candidate recommended contents.

5. The method according to claim 3, wherein obtaining the cache validity period corresponding to each candidate recommended content comprises:
obtaining an update frequency and a degree of importance corresponding to the candidate recommended content; and
configuring, based on the update frequency and the degree of importance, the cache validity period corresponding to the candidate recommended content.

6. The method according to claim 3, further comprising:
in response to candidate recommended content corresponding to the target request identifier not being in the cache or the cache validity period corresponding to the candidate recommended content being invalid, obtaining client information of the target client;
generating a query request based on the client information of the target client;
sending the query request to a recommendation service system, wherein the recommendation service system is configured to feed back the target recommended content based on the client information in the query request; and
receiving the target recommended content from the recommendation service system, writing the target recommended content into the cache, and sending the target recommended content to the target client.

7. The method according to claim 1, further comprising:
triggering a cache clearing mechanism in response to the request type being a non-retry type; and
querying, in the cache based on the cache clearing mechanism, a historical request identifier corresponding to the target client, and clearing historical recommended content corresponding to the historical request identifier from the cache, wherein the historical request identifier is a previous request identifier of the target request identifier.

8. An electronic device, comprising:
a memory and a processor, wherein the memory and the processor are in communication connection to each other, the memory stores computer instructions which, when executed by the processor, cause the processor to:
receive a content recommendation request from a target client, wherein the content recommendation request comprises a target request identifier;
verify the target request identifier to obtain a request type corresponding to the content recommendation request;
in response to the request type being a retry type, obtain a corresponding target recommended content from a cache by using the target request identifier, wherein the cache is configured to store request identifiers corresponding to different clients and recommended content corresponding to the request identifiers; and
send the target recommended content to the target client.

9. The electronic device according to claim 8, wherein the instructions causing the processor to verify the target request identifier to obtain the request type corresponding to the content recommendation request further cause the processor to:
obtain a historical content recommendation request set corresponding to the target client;
detect whether the historical content recommendation request set contains a historical content recommendation request that includes the target request identifier; and
in response to detecting the historical content recommendation request that includes the request identifier, determine that the request type is the retry type; or, in response to not detecting the historical content recommendation request that includes the request identifier, determine that the request type is a non-retry type.

10. The electronic device according to claim 8, wherein the instructions causing the processor to obtain the corresponding target recommended content from the cache by using the target request identifier further cause the processor to:
query the cache to obtain a plurality of candidate recommended contents corresponding to the target request identifier;
obtain a cache validity period corresponding to each candidate recommended content; and
obtain a current timestamp, and use, as the target recommended content, recommended content with a cache validity period in which the current timestamp falls.

11. The electronic device according to claim 10, wherein the instructions causing the processor to query the cache to obtain the candidate recommended contents corresponding to the target request identifier further cause the processor to:
obtain an account identifier and a device identifier corresponding to the target client, wherein the device identifier is an identifier of a smart device on which the target client is located;
generate a query condition based on the account identifier, the device identifier, and the target request identifier; and
query the cache by using the query condition, to obtain the candidate recommended contents.

12. The electronic device according to claim 10, wherein the instructions causing the processor to obtain the cache validity period corresponding to each candidate recommended content further cause the processor to:
obtain an update frequency and a degree of importance corresponding to the candidate recommended content; and
configure, based on the update frequency and the degree of importance, the cache validity period corresponding to the candidate recommended content.

13. The electronic device according to claim 10, the instructions further cause the processor to:
in response to candidate recommended content corresponding to the target request identifier not being in the cache or the cache validity period corresponding to the candidate recommended content being invalid, obtain client information of the target client;
generate a query request based on the client information of the target client;
send the query request to a recommendation service system, wherein the recommendation service system is configured to feed back the target recommended content based on the client information in the query request; and
receive the target recommended content from the recommendation service system, write the target recommended content into the cache, and send the target recommended content to the target client.

14. The electronic device according to claim 8, the instructions further cause the processor to:
trigger a cache clearing mechanism in response to the request type being a non-retry type; and
query, in the cache based on the cache clearing mechanism, a historical request identifier corresponding to the target client, and clear historical recommended content corresponding to the historical request identifier from the cache, wherein the historical request identifier is a previous request identifier of the target request identifier.

15. A non-transitory computer-readable storage medium having computer instructions stored thereon, wherein the computer instructions are configured to cause a computer to:
receive a content recommendation request from a target client, wherein the content recommendation request comprises a target request identifier;
verify the target request identifier to obtain a request type corresponding to the content recommendation request;
in response to the request type being a retry type, obtain a corresponding target recommended content from a cache by using the target request identifier, wherein the cache is configured to store request identifiers corresponding to different clients and recommended content corresponding to the request identifiers; and
send the target recommended content to the target client.

16. The non-transitory computer-readable storage medium according to claim 15, wherein the computer instructions causing the computer to verify the target request identifier to obtain the request type corresponding to the content recommendation request further cause the computer to:
obtain a historical content recommendation request set corresponding to the target client;
detect whether the historical content recommendation request set contains a historical content recommendation request that includes the target request identifier; and
in response to detecting the historical content recommendation request that includes the request identifier, determine that the request type is the retry type; or, in response to not detecting the historical content recommendation request that includes the request identifier, determine that the request type is a non-retry type.

17. The non-transitory computer-readable storage medium according to claim 15, wherein the computer instructions causing the computer to obtain the corresponding target recommended content from the cache by using the target request identifier further cause the computer to:
query the cache to obtain a plurality of candidate recommended contents corresponding to the target request identifier;
obtain a cache validity period corresponding to each candidate recommended content; and
obtain a current timestamp, and use, as the target recommended content, recommended content with a cache validity period in which the current timestamp falls.

18. The non-transitory computer-readable storage medium according to claim 17, wherein the computer instructions causing the computer to query the cache to obtain the candidate recommended contents corresponding to the target request identifier further cause the computer to:
obtain an account identifier and a device identifier corresponding to the target client, wherein the device identifier is an identifier of a smart device on which the target client is located;
generate a query condition based on the account identifier, the device identifier, and the target request identifier; and
query the cache by using the query condition, to obtain the candidate recommended contents.

19. The non-transitory computer-readable storage medium according to claim 17, wherein the computer instructions causing the computer to obtain the cache validity period corresponding to each candidate recommended content further cause the computer to:
obtain an update frequency and a degree of importance corresponding to the candidate recommended content; and
configure, based on the update frequency and the degree of importance, the cache validity period corresponding to the candidate recommended content.

20. The non-transitory computer-readable storage medium according to claim 17, the computer instructions further cause the computer to:
in response to candidate recommended content corresponding to the target request identifier not being in the cache or the cache validity period corresponding to the candidate recommended content being invalid, obtain client information of the target client;
generate a query request based on the client information of the target client;
send the query request to a recommendation service system, wherein the recommendation service system is configured to feed back the target recommended content based on the client information in the query request; and
receive the target recommended content from the recommendation service system, write the target recommended content into the cache, and send the target recommended content to the target client.
